(19) United States
(12) Patent Application Publication
(10) Pub. No.: US 2009/0293066 A1
(43) Pub. Date: Nov. 26, 2009

(54) SYSTEMS AND METHODS FOR REMOTING CALLS ISSUED TO EMBEDDED OR LINKED OBJECT INTERFACES

(76) Inventor: Anthony Low, St. Ives NSW (AU)

Correspondence Address: CHOATE, HALL & STEWART / CITRIX SYSTEMS, INC., TWO INTERNATIONAL PLACE, BOSTON, MA, 02110, US

(21) Appl. No.: 12/469,667

(22) Filed: May 20, 2009

Related U.S. Application Data
(60) Provisional application No. 61/054,494, filed on May 20, 2008.

(51) Int. Cl. G06F 9/46; G06F 13/00

(52) U.S. Cl. 719/316

(57) ABSTRACT

Described are methods and systems for transmitting calls issued by container applications to linked and embedded objects from one computing machine to another. An object module manager can launch a proxy server application in response to the activation of an object associated with the proxy server application. The proxy server application can then intercept a call issued by a container application, transmit the intercepted call to a proxy container application executing on a remote computing machine and receive a response generated by a server application executing on the remote computing machine. The proxy container application issues the call to the server application causing the server application to generate the response transmitted to the proxy server application. Upon receiving the response, the proxy server application can forward the response to the container application.

### RELATED APPLICATIONS

This U.S. patent application claims priority to U.S. Provisional Patent Application Ser. No. 61/054,494, filed on May 20, 2008, the disclosure of which is considered part of the disclosure of this application and is herein incorporated by reference in its entirety.

### FIELD OF THE INVENTION

This application relates generally to systems and methods for remotely interacting with embedded and linked objects. In particular, this application relates to remoting calls to embedded and linked objects.

### BACKGROUND OF THE INVENTION

Some applications can provide users with the ability to embed objects into the application or to link objects to an application. For example, a MICROSOFT EXCEL document can in some instances be embedded into a MICROSOFT WORD document such that the MICROSOFT EXCEL document can be accessed via the MICROSOFT WORD document. In this example, the MICROSOFT EXCEL document is embedded in the MICROSOFT WORD document. Embedding one object in another can be accomplished, in some instances, using MICROSOFT object linking and embedding (OLE) technology to link and embed objects into container applications. OLE technology utilizes an OLE container and OLE server application programs to implement OLE interfaces that can interact to create content rich OLE compound documents that include content (OLE objects) created by different OLE server applications. Different OLE object types can be created such that each OLE object type can be handled by a different OLE server. OLE interfaces, on the other hand, typically comprise a subset of the interfaces that are normally implemented by a graphical user interface (GUI) based OLE application. Other interfaces can enable the OLE application to display graphical output in a window, accept keyboard and mouse input, input and output sound, read and write to files, and perform many other functions.

OLE based applications typically interact with each other on a single machine. While this technology can be extended to work across different machines, i.e. the Distributed Component Object Model (DCOM) technology, OLE can operate only when the OLE container application and OLE server application are present on a single machine. For example, a MICROSOFT WORD document having an embedded EXCEL table cannot be properly displayed on a machine that has a MICROSOFT WORD install but not a MICROSOFT EXCEL install. Activating an embedded or linked object results in the OLE server application associated with the object type being launched and the object passed to the launched OLE server application. Once the OLE server application launches, the user can interact with the OLE server application to edit the object. Changes made to the embedded or linked object by the user are reflected in the compound container document as they are made and are permanent once the changes are saved on the OLE server application.

If no OLE server application exists on the computing machine, then an error can occur when an embedded or linked object is activated. This problem necessitates the need for a system or method of remotely providing container applications having objects that are linked, embedded or otherwise associated with the container application even when the server application cannot be accessed by the computer. Thus, there is a need to enable a user to activate an embedded or linked object and interact with a remote OLE application as if the OLE application resides locally.

### SUMMARY OF THE INVENTION

In its broadest interpretation, this disclosure describes methods and systems for providing remote access to linked or embedded objects. Activating an embedded or linked object requires activation of the OLE server application associated with that particular object. For example, editing or otherwise accessing an embedded MICROSOFT ACCESS table requires launching the corresponding OLE server application MICROSOFT ACCESS. In instances where the OLE server application is not installed on the remote computing machine, activation of an embedded or linked object can be frustrated by errors caused by the inability to locate the OLE server application. Described herein are methods and systems for responding to OLE interface calls when the OLE server application is not installed on the remote computing machine.

In one instance, described herein is an embodiment of a method for remoting calls issued by container applications to linked and embedded objects that includes launching, by an object module manager executing on a first computing machine, a proxy server application on the first computing machine responsive to activating an object associated with the proxy server application. The proxy server application then intercepts a call issued by a container application executing on the first computing machine, and transmits over a virtual channel via a presentation level protocol, the intercepted call to a proxy container application executing on a second computing machine. The proxy container then invokes the call on a server application executing on the second computing machine and associated with the object. The proxy server application then receives from the proxy container application via the virtual channel, a response generated by the server application and comprising data associated with the object. Upon receiving the response, the proxy server application forwards the received response to the container application.

In one embodiments, intercepting a call can further comprise intercepting a call requesting access to a linked and embedded object interface on the server application. In other embodiments, intercepting a call can further comprise intercepting a method call.

Launching the proxy server application can, in some embodiments, comprise launching a proxy server application associated with the activated object.

In one embodiment, the proxy server application receives from the proxy container application a second call issued by the server application to an interface on the container application, the second call transmitted by the proxy container application to the proxy server application over the virtual channel. The proxy server application then invokes the second call on the container application.

The server application, in some embodiments, can further comprise an object linking and embedding server application associated with the activated object. In other embodiments, the proxy server application can correspond to the server application on the second computing machine. The container application can, in some embodiments, correspond to the proxy container application on the second computing machine. In other embodiments, the container application executes on a third computing machine.

In one embodiment the proxy server application marshals the call prior to transmitting the call to the proxy container application, and the proxy container application un-marshals the call prior to invoking the call on the server application. In other embodiments, the proxy container application marshals the response to the call prior to transmitting the response to the proxy server application, and the proxy server application un-marshals the response prior to transmitting the response to the container application.

The first computing machine and the second computing machine, in some embodiments, are substantially the same computing machine. In other embodiments, invoking the request, by the proxy container application, includes invoking the request issued by the container application on the server application after receiving the request from the proxy server application. The proxy container application then transmits a pointer to an interface associated with an object created by the server application responsive to the request, the object corresponding to the object instance. In one embodiment, the proxy server application stores the received pointer in a table and maps the object instance to the stored pointer. The table can in some embodiments be on the first computing machine and in other embodiments can be on a computing machine remotely located from the first computing machine.

The container application, in some embodiments, can execute on a third computing machine. In other embodiments, the presentation level protocol remotes keyboard input, mouse input, audio output and screen updates between computing machines.

In some instances, the methods and processes described above can be carried out by executable instructions stored on a computer readable medium.

In other instances, described herein is an embodiment of a system for remoting calls issued by container applications to linked and embedded objects. Included in the system is an object module executing on a first computing machine, the object module detecting activation of an object and responsively launching a to launch a proxy server application associated with the object. Also included is a container application executing on the first computing machine and issuing a call to an interface on a server application executing on a second computing machine, a server application executing on the second computing machine, the server application associated with the object, a proxy container application executing on the second computing machine and invoking received calls on the server application, and a proxy server application executing on the first computing machine. The proxy server application can: intercept the call issued by the container application; transmit the call to the proxy container application over a virtual channel; receive from the proxy container application, via the virtual channel, a response generated by the server application and comprising data associated with the object; and forward the received response to the container application.

### BRIEF DESCRIPTION OF THE DRAWINGS

The following figures depict certain illustrative embodiments of a method and system for providing remote access to embedded or linked objects, where like reference numerals refer to like elements. Each depicted embodiment is illustrative of the method and system and not limiting.

FIG. 1A is a block diagram illustrative of an embodiment of a remote-access, networked environment with a client machine that communicates with a server.

FIGS. 1B and 1C are block diagrams illustrative of an embodiment of computing machines for practicing the methods and systems described herein.

FIG. 1D is a block diagram illustrative of an embodiment of a server farm.

FIG. 2 is a block diagram illustrative of an embodiment of a system that allows for remote interaction with embedded or linked objects.

FIG. 3 is a block diagram illustrative of an embodiment of a system that allows for remote interaction with embedded or linked objects.

FIG. 4 is a block diagram illustrative of an embodiment of a system that allows for remote interaction with embedded or linked objects.

FIG. 5A is a flow chart illustrative of an embodiment of a method for remoting a call to a linked and embedded object interface.

FIG. 5B is a flow chart illustrative of an embodiment of a method for remoting a call to an interface on a container application.

FIG. 6 is a flow chart illustrative of an embodiment of a method for remoting a call to an interface on a container application.

### DETAILED DESCRIPTION

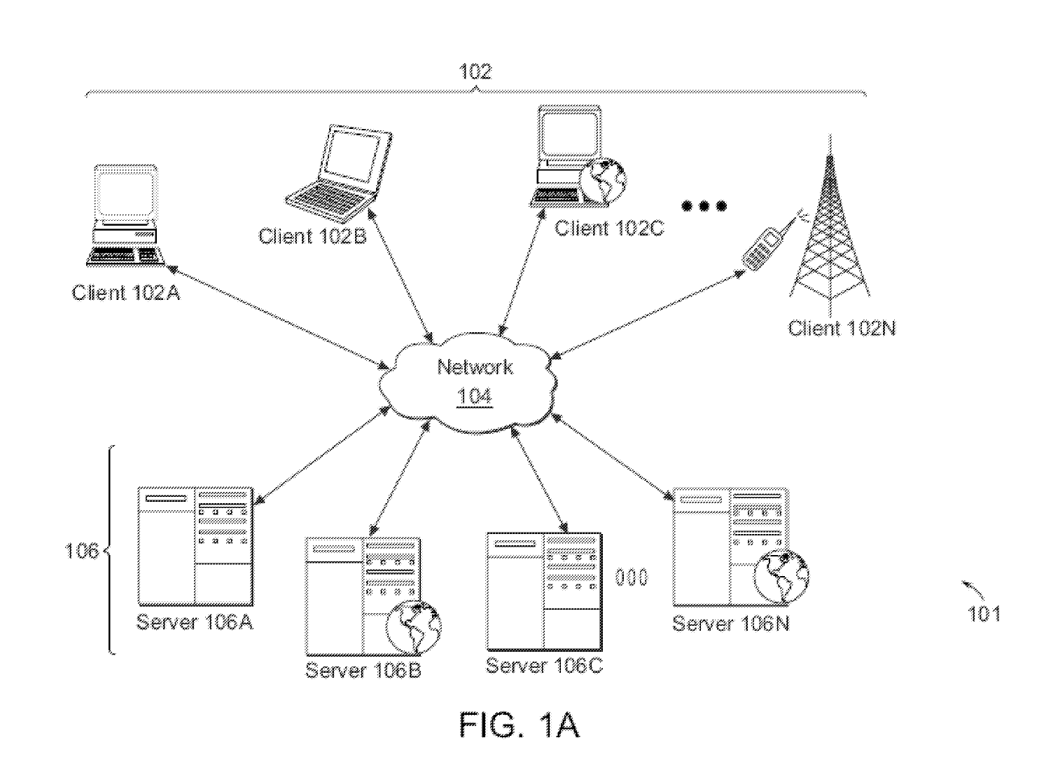

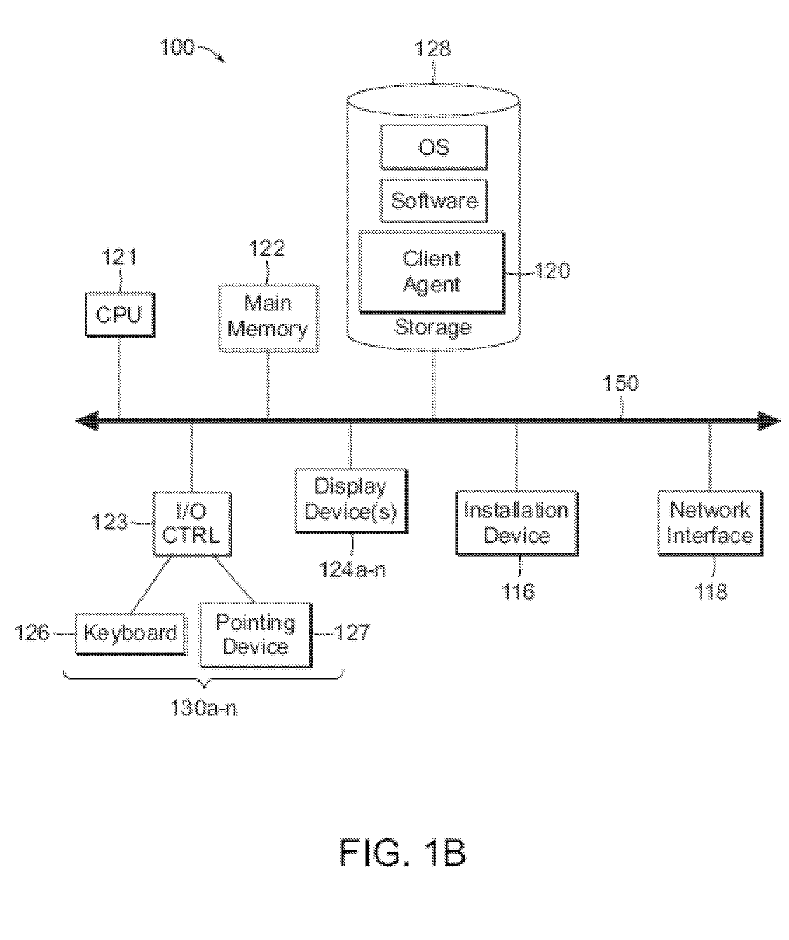

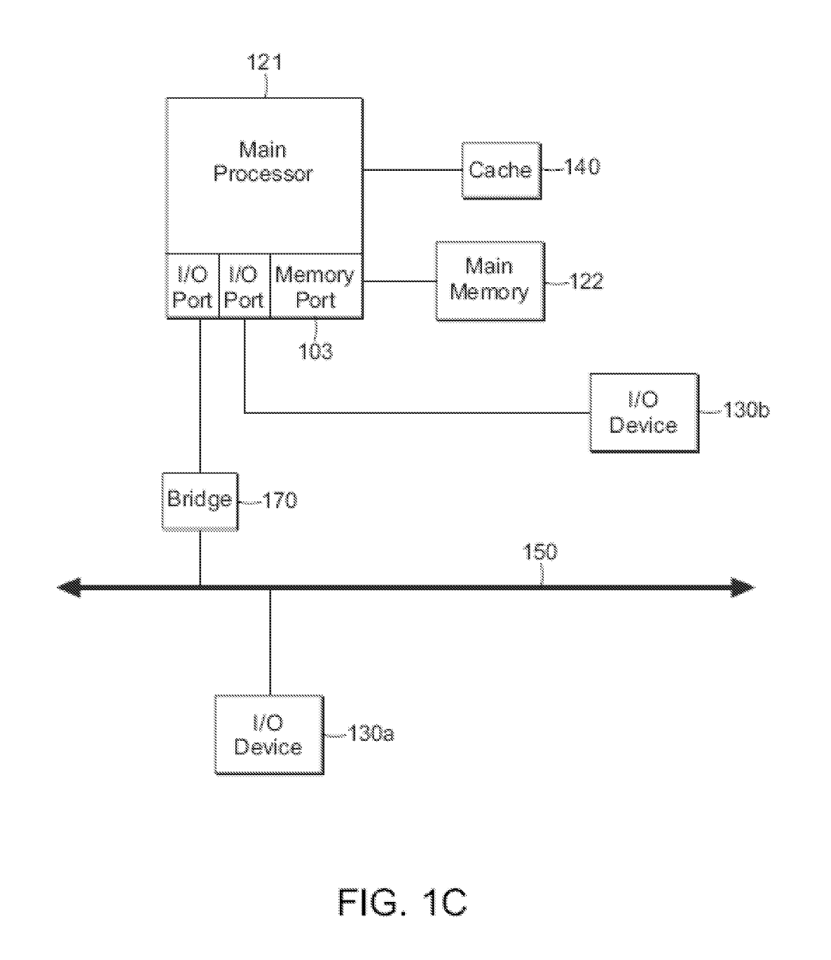

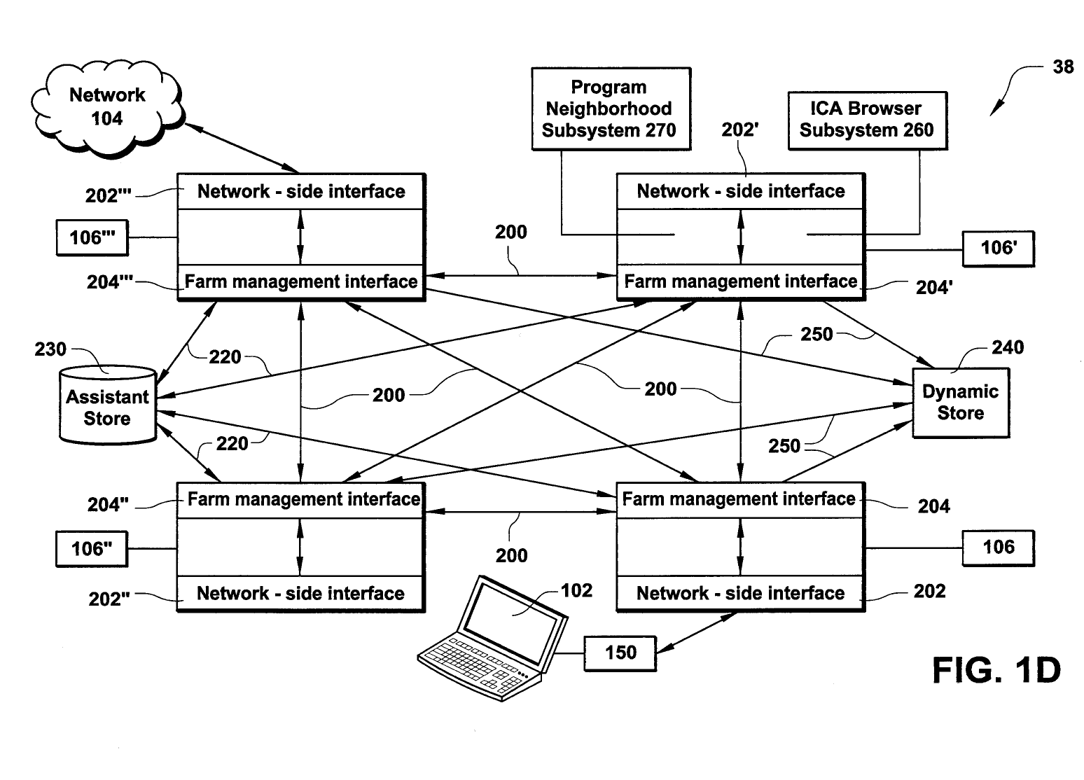

FIG. 1A illustrates one embodiment of a computing environment 101 that includes one or more client machines 102A-102N in communication with servers 106A-106N, and a network 104 installed in between the client machines 102A-102N and the servers 106A-106N. In some embodiments, client machines 102A-102N may be referred to as a single client machine 102 or a single group of client machines 102, while servers may be referred to as a single server 106 or a single group of servers 106. One embodiment includes a single client machine 102 communicating with more than one server 106, another embodiment includes a single server 106 communicating with more than one client machine 102, while another embodiment includes a single client machine 102 communicating with a single server 106.

A client machine 102 within the computing environment may in some embodiments, be referenced by any one of the following terms: client machine(s) 102; client(s); client computer(s); client device(s); client computing device(s); local machine; remote machine; client node(s); endpoint(s); endpoint node(s); or a second machine. The server 106 in some embodiments may be referenced by any one of the following terms: server(s), local machine; remote machine; server farm(s), host computing device(s), or a first machine(s).

The client machine 102 can in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 102. Still other embodiments may include a computing environment 101 with an application that is any of either server-based or remote-based, and an application that is executed on the server 106 on behalf of the client machine 102. Further embodiments of the computing environment 101 include a server 106 configured to display output graphical data to a client machine 102 using a thin-client or remote-display protocol, where the protocol used can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

In one embodiment, the client machine 102 can be a virtual machine 102C such as those manufactured by XenSolutions, Citrix Systems, IBM, VMware, or any other virtual machine able to implement the methods and systems described herein.

The computing environment 101 can, in some embodiments, include more than one server 106A-106N where the servers 106A-106N are: grouped together as a single server 106 entity, logically-grouped together in a server farm 106; geographically dispersed and logically grouped together in a server farm 106, located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity or in other embodiments may include multiple server farms 106. The computing environment 101 can include more than one server 106A-106N grouped together in a single server farm 106 where the server farm 106 is heterogeneous such that one server 106A-106N is configured to operate according to a first type of operating system platform (e.g., WINDOWS NT, manufactured by Microsoft Corp. of Redmond, Wash.), while one or more other servers 106A-106N are configured to operate according to a second type of operating system platform (e.g., Unix or Linux); more than one server 106A-106N is configured to operate according to a first type of operating system platform (e.g., WINDOWS NT), while another server 106A-106N is configured to operate according to a second type of operating system platform (e.g., Unix or Linux); or more than one server 106A-106N is configured to operate according to a first type of operating system platform (e.g., WINDOWS NT) while more than one of the other servers 106A-106N are configured to operate according to a second type of operating system platform (e.g., Unix or Linux).

The computing environment 101 can in some embodiments include a server 106 or more than one server 106 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 configured to operate as an Active Directory; a server 106 configured to operate as application acceleration application that provides firewall functionality, application functionality, or load balancing functionality, or other type of computing machine configured to operate as a server 106. In some embodiments, a server 106 may include a remote authentication dial-in user service such that the server 106 is a RADIUS server. Embodiments of the computing environment 101 where the server 106 comprises an appliance, the server 106 can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a server 106 with the following functionality: a first server 106A that receives requests from a client machine 102, forwards the request to a second server 106B, and responds to the request generated by the client machine with a response from the second server 106B; acquires an enumeration of applications available to the client machines 102 and address information associated with a server 106 hosting an application identified by the enumeration of applications; presents responses to client requests using a web interface; communicates directly with the client 102 to provide the client 102 with access to an identified application; receives output data, such as display data, generated by an execution of an identified application on the server 106.

The server 106 can be configured to execute any one of the following applications: an application providing a thin-client computing or a remote display presentation application; any portion of the CITRIX ACCESS SUITE by Citrix Systems, Inc. like the METAFRAME or CITRIX PRESENTATION SERVER; MICROSOFT WINDOWS Terminal Services manufactured by the Microsoft Corporation; or an ICA client, developed by Citrix Systems, Inc. Another embodiment includes a server 106 configured to execute an application so that the server may function as an application server such as any one of the following application server types: an email server that provides email services such as MICROSOFT EXCHANGE manufactured by the Microsoft Corporation; a web or Internet server; a desktop sharing server; or a collaboration server. Still other embodiments include a server 106 that executes an application that is any one of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

In one embodiment, the server 106 may be a virtual machine 106B such as those manufactured by Citrix Systems, IBM, VMware, or any other virtual machine able to implement the methods and systems described herein.

Client machines 102 may function, in some embodiments, as a client node seeking access to resources provided by a server 106, or as a server 106 providing other clients 102A-102N with access to hosted resources. One embodiment of the computing environment 101 includes a server 106 that provides the functionality of a master node. Communication between the client machine 102 and either a server 106 or servers 106A-106N can be established via any of the following methods: direct communication between a client machine 102 and a server 106A-106N in a server farm 106; a client machine 102 that uses a program neighborhood application to communicate with a server 106a-106n in a server farm 106; or a client machine 102 that uses a network 104 to communicate with a server 106A-106N in a server farm 106. One embodiment of the computing environment 101 includes a client machine 102 that uses a network 104 to request that applications hosted by a server 106A-106N in a server farm 106 execute, and uses the network 104 to receive from the server 106A-106N graphical display output representative of the application execution. In other embodiments, a master node provides the functionality required to identify and provide address information associated with a server 106 hosting a requested application. Still other embodiments include a master node that can be any one of the following: a server 106A-106N within the server farm 106; a remote computing machine connected to the server farm 106 but not included within the server farm 106; a remote computing machine connected to a client 102 but not included within a group of client machines 102; or a client machine 102.

The network 104 between the client machine 102 and the server 106 is a connection over which data is transferred between the client machine 102 and the server 106. Although the illustration in FIG. 1A depicts a network 104 connecting the client machines 102 to the servers 106, other embodiments include a computing environment 101 with client machines 102 installed on the same network as the servers 106. Other embodiments can include a computing environment 101 with a network 104 that can be any of the following: a local-area network (LAN); a metropolitan area network (MAN); a wide area network (WAN); a primary network 104 comprised of multiple sub-networks 104′ located between the client machines 102 and the servers 106; a primary public network 104 with a private sub-network 104′; a primary private network 104 with a public sub-network 104′; or a primary private network 104 with a private sub-network 104′. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 104 that includes a wireless link where the wireless link can be an infrared channel or satellite band; or any other network type able to transfer data from client machines 102 to servers 106 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 102 to servers 106, and vice versa, to accomplish the methods and systems described herein. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (J/O) controller 123; display devices 124A-124N; an installation device 116; and a network interface 118. In one embodiment, the storage memory 128 includes: an operating system, software routines, and a client agent 120. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the central processing unit 121, where the central processing unit 121 can further communicate with a second I/O device 130B, a main memory 122, and a cache memory 140. Included within the central processing unit 121, are I/O ports, a memory port 103, and a main processor.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits capable of executing the systems and methods described herein. Still other embodiments of the central processing unit 121 may include any combination of the following: a microprocessor, a microcontroller, a central processing unit with a single processing core, a central processing unit with two processing cores, or a central processing unit with more than one processing cores.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O devices 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121 via an Advanced Graphics Port (AGP). Still other versions of the computing machine 100 include a processor 121 connected to an I/O device 130A-130N via any one of the following connections: HyperTransport, Rapid I/O, or InfiniBand. Further embodiments of the computing machine 100 include a communication connection where the processor 121 communicates with one I/O device 130A using a local interconnect bus and with a second I/O device 130B using a direct connection.

Included within some embodiments of the computing device 100 is each of a main memory unit 122 and cache memory 140. The cache memory 140 will in some embodiments be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device capable of executing the systems and methods described herein. The main memory unit 122 and/or the cache memory 140 can in some embodiments include one or more memory devices capable of storing data and allowing any storage location to be directly accessed by the central processing unit 121. Further embodiments include a central processing unit 121 that can access the main memory 122 via one of either: a system bus 150; a memory port 103; or any other connection, bus or port that allows the processor 121 to access memory 122.

One embodiment of the computing device 100 provides support for any one of the following installation devices 116: a floppy disk drive for receiving floppy disks such as 3.5-inch, 5.25-inch disks or ZIP disks, a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS), or the Citrix Gateway Protocol manufactured by Citrix Systems, Inc. Versions of the network interface 118 can comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments of an I/O device 130 may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can connect to multiple display devices 124A-124N, in other embodiments the computing device 100 can connect to a single display device 124, while in still other embodiments the computing device 100 connects to display devices 124A-124N that are the same type or form of display, or to display devices that are different types or forms. Embodiments of the display devices 124A-124N can be supported and enabled by the following: one or multiple I/O devices 130A-130N; the I/O controller 123; a combination of I/O device(s) 130A-130N and the I/O controller 123; any combination of hardware and software able to support a display device 124A-124N; any type and/or form of video adapter, video card, driver, and/or library to interface, communicate, connect or otherwise use the display devices 124a-124n. The computing device 100 may in some embodiments be configured to use one or multiple display devices 124A-124N, these configurations include: having multiple connectors to interface to multiple display devices 124a-124n; having multiple video adapters, with each video adapter connected to one or more of the display devices 124A-124N; having an operating system configured to support multiple displays 124A-124N; using circuits and software included within the computing device 100 to connect to and use multiple display devices 124A-124N; and executing software on the main computing device 100 and multiple secondary computing devices to enable the main computing device 100 to use a secondary computing device's display as a display device 124A-124N for the main computing device 100. Still other embodiments of the computing device 100 may include multiple display devices 124A-124N provided by multiple secondary computing devices and connected to the main computing device 100 via a network.

In some embodiments of the computing machine 100, an operating system may be included to control task scheduling and access to system resources. Embodiments of the computing device 100 can run any one of the following operation systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; and WINDOWS VISTA; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system capable of running on the computing device and performing the operations described herein. One embodiment of the computing machine 100 has multiple operating systems installed thereon.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. Still other embodiments of the computing environment 101 include a mobile computing device 100 that can be any one of the following: any one series of Blackberry, or other handheld device manufactured by Research In Motion Limited; the iPhone manufactured by Apple Computer; any handheld or smart phone; a Pocket PC; a Pocket PC Phone; or any other handheld mobile device supporting Microsoft Windows Mobile Software.

Referring now to FIG. 1D, together the servers 106 comprise a farm 38 or server farm, where each server 106 can include a network-side interface 202 and a farm-side interface 204. The network-side interface 202 can be in communication with one or more clients 102 or a network 104. The network 104 can be a WAN, LAN, or any other embodiment of a network such those networks described above.

Each server 106 has a farm-side interface 204 connected with one or more farm-side interface(s) 204 of other servers 106 in the farm 38. In one embodiment, each farm-side interface 204 is interconnected to other farm-side interfaces 204 such that the servers 106 within the farm 38 may communicate with one another. On each server 106, the farm-side interface 204 communicates with the network-side interface 202. The farm-side interfaces 204 can also communicate (designated by arrows 220) with a persistent store 230 and, in some embodiments, with a dynamic store 240. The combination of servers 106, the persistent store 230, and the dynamic store 240, when provided, are collectively referred to as a farm 38. In some embodiments, a server 106 communicates with the persistent store 230 and other servers 106′ communicate with the server 106 to access information stored in the persistent store.

The persistent store 230 may be physically implemented on a disk, disk farm, a redundant array of independent disks (RAID), writeable compact disc, or any other device that allows data to be read and written and that maintains written data if power is removed from the storage device. A single physical device may provide storage for a plurality of persistent stores, i.e., a single physical device may be used to provide the persistent store 230 for more than one farm 38. The persistent store 230 maintains static data associated with each server 106 in farm 38 and global data used by all servers 106 within the farm 38. In one embodiment, the persistent store 230 may maintain the server data in a Lightweight Directory Access Protocol (LDAP) data model. In other embodiments, the persistent store 230 stores server data in an ODBC-compliant database. For the purposes of this description, the term “static data” refers to data that do not change frequently, i.e., data that change only on an hourly, daily, or weekly basis, or data that never change. Each server uses a persistent storage subsystem to read data from and write data to the persistent store 230.

The data stored by the persistent store 230 may be replicated for reliability purposes physically or logically. For example, physical redundancy may be provided using a set of redundant, mirrored disks, each providing a copy of the data. In other embodiments, the database itself may be replicated using standard database techniques to provide multiple copies of the database. In further embodiments, both physical and logical replication may be used concurrently.

The dynamic store 240 (i.e., the collection of all record tables) can be embodied in various ways. In one embodiment, the dynamic store 240 is centralized; that is, all runtime data are stored in the memory of one server 106 in the farm 38. That server operates as a master network node with which all other servers 106 in the farm 38 communicate when seeking access to that runtime data. In another embodiment, each server 106 in the farm 38 keeps a full copy of the dynamic store 240. Here, each server 106 communicates with every other server 106 to keep its copy of the dynamic store 240 up to date.

In another embodiment, each server 106 maintains its own runtime data and communicates with other servers 106 when seeking to obtain runtime data from them. Thus, for example, a server 106 attempting to find an application program requested by the client 102 may communicate directly with every other server 106 in the farm 38 to find one or more servers hosting the requested application.

For farms 38 having a large number of servers 106, the network traffic produced by these embodiments can become heavy. One embodiment alleviates heavy network traffic by designating a subset of the servers 106 in a farm 38, typically two or more, as “collector points.” Generally, a collector point is a server that collects run-time data. Each collector point stores runtime data collected from certain other servers 106 in the farm 38. Each server 106 in the farm 38 is capable of operating as, and consequently is capable of being designated as, a collector point. In one embodiment, each collector point stores a copy of the entire dynamic store 240. In another embodiment, each collector point stores a portion of the dynamic store 240, i.e., it maintains runtime data of a particular data type. The type of data stored by a server 106 may be predetermined according to one or more criteria. For example, servers 106 may store different types of data based on their boot order. Alternatively, the type of data stored by a server 106 may be configured by an administrator using an administration tool (Not Shown.) In these embodiments, the dynamic store 240 is distributed amongst two or more servers 106 in the farm 38.

Servers 106 not designated as collector points know the servers 106 in a farm 38 that are designated as collector points. A server 180 not designated as a collector point may communicate with a particular collector point when delivering and requesting runtime data. Consequently, collector points lighten network traffic because each server 106 in the farm 38 communicates with a single collector point server 106, rather than with every other server 106, when seeking to access the runtime data.

Each server 106 can operate as a collector point for more than one type of data. For example, server 106″ can operate as a collector point for licensing information and for loading information. In these embodiments, each collector point may amass a different type of run-time data. For example, to illustrate this case, the server 106″′ can collect licensing information, while the server 106″ collects loading information.

In some embodiments, each collector point stores data that is shared between all servers 106 in a farm 38. In these embodiments, each collector point of a particular type of data exchanges the data collected by that collector point with every other collector point for that type of data in the farm 38. Thus, upon completion of the exchange of such data, each collector point 106″ and 106 possesses the same data. Also in these embodiments, each collector point 106 and 106″ also keeps every other collector point abreast of any updates to the runtime data.

Browsing enables a client 102 to view farms 38, servers 106, and applications in the farms 38 and to access available information such as sessions throughout the farm 38. Each server 106 includes an ICA browsing subsystem 260 to provide the client 102 with browsing capability. After the client 102 establishes a connection with the ICA browser subsystem 260 of any of the servers 106, that browser subsystem supports a variety of client requests. Such client requests include: (1) enumerating names of servers in the farm, (2) enumerating names of applications published in the farm, (3) resolving a server name and/or application name to a server address that is useful the client 102. The ICA browser subsystem 260 also supports requests made by clients 10 running a program neighborhood application that provides the client 102, upon request, with a view of those applications within the farm 38 for which the user is authorized. The ICA browser subsystem 260 forwards all of the above-mentioned client requests to the appropriate subsystem in the server 106.

In one embodiment, each server 106 in the farm 38 that has a program neighborhood subsystem 270 can provide the user of a client 102 with a view of applications within the farm 38. The program neighborhood subsystem 270 may limit the view to those applications for which the user of the client 102 has authorization to access. Typically, this program neighborhood service presents the applications to the user as a list or a group of icons.

The functionality provided by the program neighborhood subsystem 270 can be available to two types of clients, (1) program neighborhood-enabled clients that can access the functionality directly from a client desktop, and (2) non-program neighborhood-enabled clients (e.g., legacy clients) that can access the functionality by running a program neighborhood-enabled desktop on the server.

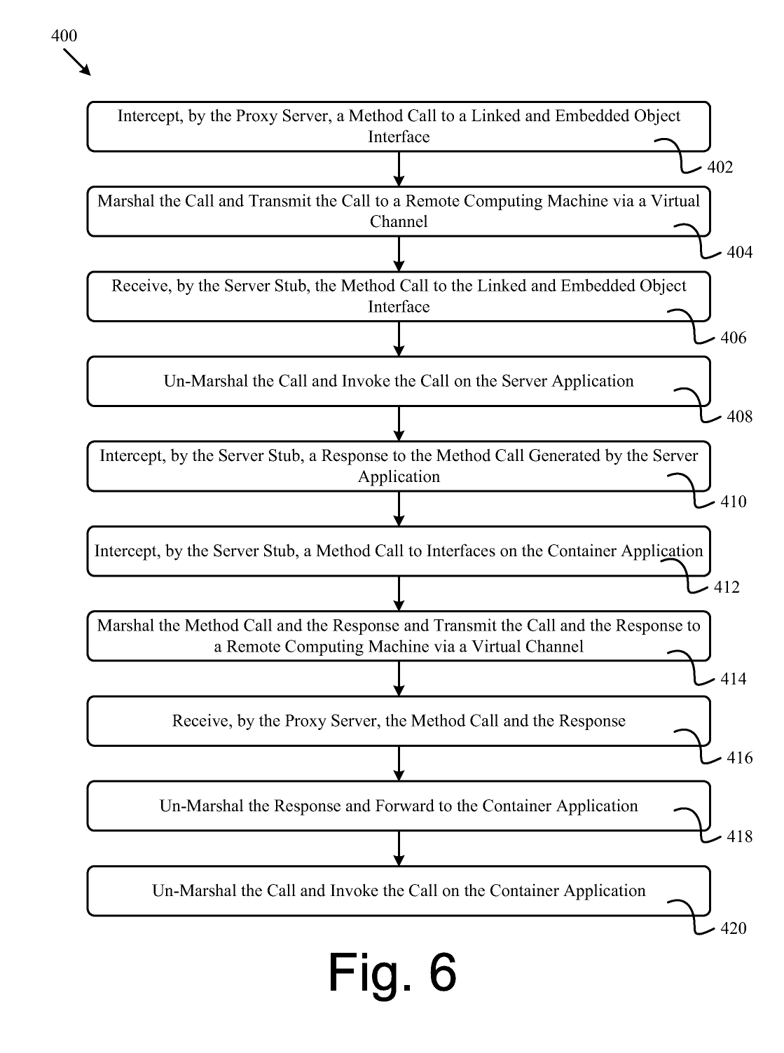

Communication between a program neighborhood-enabled client and the program neighborhood subsystem 270 may occur over a dedicated virtual channel that is established on top of an ICA virtual channel. In other embodiments, the communication occurs using an XML service. In one of these embodiments, the program neighborhood-enabled client communicates with an XML subsystem, such as the XML service 516 described in connection with FIG. 6 below, providing program neighborhood functionality on a server 106.

In one embodiment, the program neighborhood-enabled client does not have a connection with the server with a program neighborhood subsystem 270. For this embodiment, the client 102 sends a request to the ICA browser subsystem 260 to establish an ICA connection to the server 106 in order to identify applications available to the client 102. The client 102 then runs a client-side dialog that acquires the credentials of a user. The credentials are received by the ICA browser subsystem 260 and sent to the program neighborhood subsystem 270. In one embodiment, the program neighborhood subsystem 270 sends the credentials to a user management subsystem for authentication. The user management subsystem may return a set of distinguished names representing the list of accounts to which the user belongs. Upon authentication, the program neighborhood subsystem 270 establishes the program neighborhood virtual channel. This channel remains open until the application filtering is complete.

The program neighborhood subsystem 270 then requests the program neighborhood information from the common application subsystem 524 associated with those accounts. The common application subsystem 524 obtains the program neighborhood information from the persistent store 230. On receiving the program neighborhood information, the program neighborhood subsystem 270 formats and returns the program neighborhood information to the client over the program neighborhood virtual channel. Then the partial ICA connection is closed.

For another example in which the program neighborhood-enabled client establishes a partial ICA connection with a server, consider the user of the client 102 who selects a farm 38. The selection of the farm 38 sends a request from the client 102 to the ICA browser subsystem 260 to establish an ICA connection with one of the servers 106 in the selected farm 38. The ICA browser subsystem 260 sends the request to the program neighborhood subsystem 270, which selects a server 106 in the farm 38. Address information associated with the server 106 is identified and returned to the client 102 by way of the ICA browser subsystem 260. The client 102 can then subsequently connect to the server 106 corresponding to the received address information.

In another embodiment, the program neighborhood-enabled client 102 establishes an ICA connection upon which the program neighborhood-virtual channel is established and remains open for as long as the ICA connection persists. Over this program neighborhood virtual channel, the program neighborhood subsystem 270 pushes program neighborhood information updates to the client 102. To obtain updates, the program neighborhood subsystem 270 subscribes to events from the common application subsystem 524 to allow the program neighborhood subsystem 270 to detect changes to published applications.

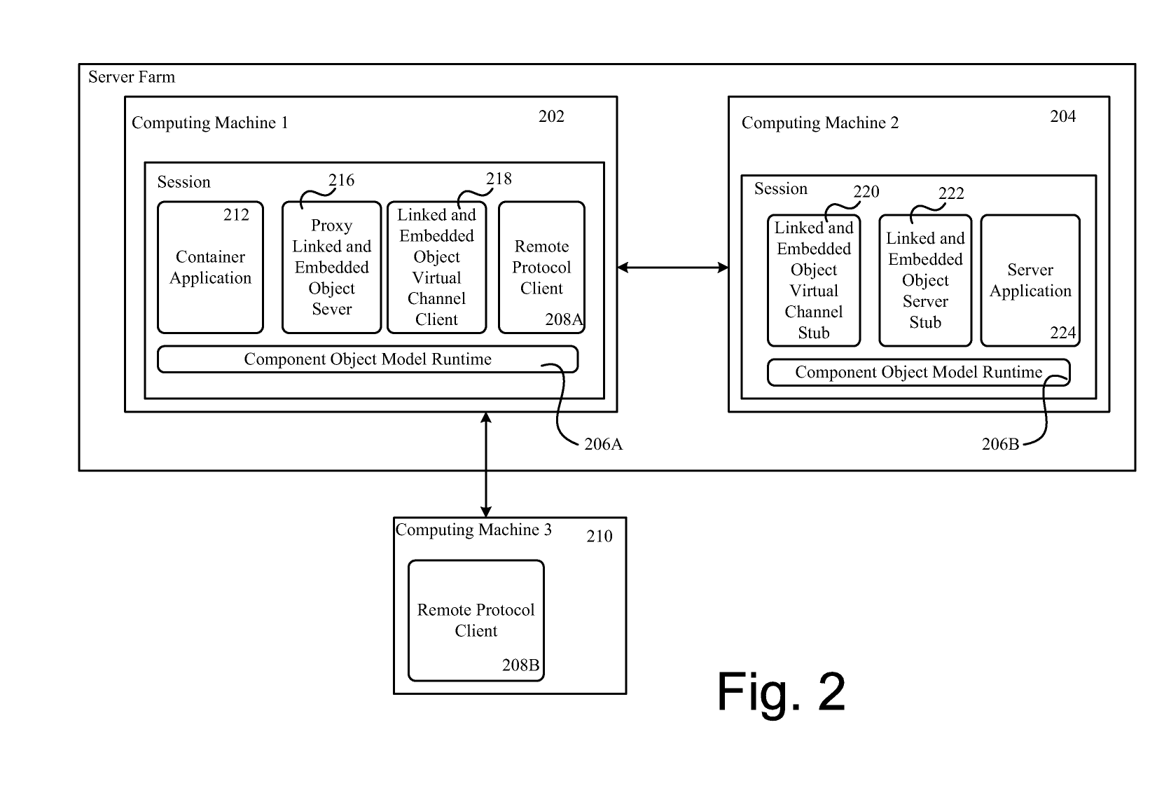

Illustrated in FIG. 2, is one embodiment of a system for remotely providing access to linked and embedded objects. The system can include a first computing machine 202 and a second computing machine 204 in a server farm, where the first computing machine 202 communicates with a third computing machine 210. In one embodiment, the first computing machine 202 executes within a session the following components: a component object module runtime 206A; a container application 212; a proxy linked and embedded object server 216; a linked and embedded object virtual channel client 218; and a remote protocol client 208A. The first computing machine 202 can communicate with the second computing machine 204 via a virtual channel (Not Shown) established between the computing machines. Communication over the virtual channel can include using a presentation level protocol to transmit packets from one remote protocol client to another. Executing on the second computing machine 204, and within a session, are the following components: a linked and embedded object virtual channel stub 220; a linked and embedded object server stub 222; a server application 224; and a component object model runtime 206B. Communicating with the first computing machine 202 via a virtual channel (Not Shown) established between the computing machines and via a presentation level protocol is a third computing machine 210. Executing on the third computing machine 210 is a remote protocol client 208B.

Further referring to FIG. 2, and in more detail, in one embodiment, the first computing machine 202 and the second computing machine 204 are servers 106 and can be any of the above-described embodiments of a server 106. In this embodiment, the third computing machine 210 is a client 102 and can be any of the above-described embodiments of a client computing machine 102. Other embodiments include a first, second and third computing machine 202, 204, 210 where each is a client computing machine 102. Still other embodiments include a first, second and third computing machine 202, 204, 210 where each is a server 106. In still other embodiments, the first, second and third computing machine 202, 204, 210 can be any combination of server(s) 106 and client(s) 102. The second computing machine 204, in some embodiments, can be a virtual machine executing on the first computing machine 202, while in some embodiments, the first computing machine 202 can be a virtual machine executing on the second computing machine 204. In still other embodiments, each of the first and second computing machine 202, 204 can be a virtual machine such that both the first and second computing machines 202, 204 are executing on the same physical machine. Each of the first, second and third computing machines 202, 204, 210 can, in some embodiments, communicate via a network 104 such as any of the above-described embodiments of a network 104.

In one embodiment, the first computing machine 202 can communicate with the second computing machine 204 via a virtual communication channel (Not Shown) established between the first computing machine 202 and the second computing machine 204. This virtual communication channel can be referred to as a communication channel, virtual channel or channel. In one embodiment the virtual communication channel is an ICA channel which is a communication channel over which communication can be sent using CITRIX SYSTEMS INC. ICA protocol. In other embodiments, data, data packets or other communication can be sent over the virtual channel using any remote presentation protocol. The remote presentation protocol can be the RDP protocol, the ICA protocol, PCAnywhere, or any other remote presentation protocol.

In some embodiments, the first computing machine 202 can communicate with the third computing machine 210 via a virtual communication channel (Not Shown) such as any of the virtual communication channels described herein. Data, data packets, communication and any other information can be transmitted over the virtual communication channel via any of the presentation level protocols described herein.

In some embodiments, the session executing on each of the first computing machine 202 and the second computing machine 204 is a session corresponding to a user connected to the first computing machine 202 via the third computing machine 210 and the remote protocol client 208B. This user session can be instantiated when a user uses the third computing machine 210 to access the remote protocol client 208A and cause a user session to be created. Applications executing within the user session, in some embodiments, are specific to the user accessing the applications via the third computing machine 210. These applications are specific to a particular user in the sense that the application is configured according to the user's specifications and according to a configuration file associated with the user. Accessible within the session, in some embodiments, is a user-specific profile and user-specific file directory that enumerates each of the files, configurations, settings, applications and information specific to a particular user. Other embodiments include a first or second computing machine 202, 204 where either or both machines do not execute aspects of the system within a session.

Executing on the third computing machine 210, in some embodiments, is a remote protocol client 208B that can be used to establish a virtual channel between the first computing machine 202 and the third computing machine 210. Further, the remote protocol client 208B can communicate with a remote protocol client 208A executing on the first computing machine 202 to receive data packets from the first computing machine 202 and transmit data packets to the first computing machine 202, and vice versa. The remote protocol client 208B, in some embodiments, can be the ICA client developed by CITRIX SYSTEMS INC.

The remote protocol client 208B executing on the third computing machine 210 can communicate with the remote protocol client 208A on the first computing machine 202. The remote protocol client 208A executing on the first computing machine 202 can in some embodiments be the same as the remote protocol client 208B. In one embodiment, the remote protocol client 208A can establish a virtual communication channel between the first computing machine 202 and the third computing machine 210.

In some embodiments, the linked and embedded object virtual channel client 218 can be used to locate and launch the linked and embedded object server stub 222 associated with the server application 224 required by the container application 212, and to launch the stub 222 in a seamless window session. In many embodiments, the linked and embedded object virtual channel client 218 is configured to do the following: connect to a computing machine able to publish the linked and embedded object server stub 222 in a seamless window session; create a virtual channel between the two computing machines 202, 204 for transmitting data between the linked and embedded object virtual channel client 218 and the linked and embedded object virtual channel stub 220; output graphical content to a user on the third computing machine 210, the graphical output representative in part of the embedded or linked content; provide to the system input from input devices remote from either the first or second computing machine 202, 204; and notify the proxy server 216 when the session is logged off or terminated. The linked and embedded object virtual channel client 218 can in many embodiments be launched by the proxy server 216 and can be further configured by the proxy server 216 so that the client 208A is able to locate and launch a server stub 222 that corresponds to the proxy server 216. Location and launching of a server stub 222, in many embodiments, further relies on the publishing of an adequate stub 222 by the second computing machine 204. Once the stub 222 is located and launched, the remote protocol client 208A or the linked and embedded object virtual channel client 218 further relies on the stub to launch the server application 224 that corresponds to the proxy linked and embedded object server 216 such that the proxy server 216 and the stub 222 are endpoints of a virtual channel created between the first and second computing machine 202, 204. While in some embodiments the linked and embedded object virtual channel client 218 can facilitate the above functionalities, in other embodiments the remote protocol client 208A can facilitate establishing a virtual channel and facilitating communication between the linked and embedded object virtual channel client 218 and the linked and embedded object virtual channel stub 220 executing on the second computing machine 204.

The container application 212 within the session executing on the first computing machine 202, is in some embodiments an application that creates a container object to hold embedded or linked objects created by either the container application 212 or a different application able of creating embedded or linked objects. In such embodiments, the container application 212 corresponds in part to the server application 224 resident within the session executing on the second computing machine 204 such that activation of the server application 224 occurs when one performs an operation on an embedded or linked object within the container application 212. Operations that can cause this result include any of the following: playing; editing; opening; closing; moving; activating; altering; copying; or otherwise performing an operation of an embedded or linked object. The container application 212, in many embodiments, is responsible for performing the following tasks: creating a document or other object having an embedded object or link; saving an embedded object or link to a persistent storage repository; loading an embedded object or link from persistent storage; displaying the compound document renditions of the embedded objects and links; and activating the linked and embedded object server. In order to locate the linked and embedded object server stub 222 associated with an embedded or linked object activated within the container application 212, the container application 212 in many embodiments, can rely on the component object model runtime 206A, 206B to locate the linked and embedded object server proxy 216 and stub 222. The component object model runtimes 206A, 206B are further configured to proxy many of the interface calls and responses generated between the container application 212 and the linked and embedded server proxy 216, and to proxy calls between the linked and embedded object server stub 222 and the server application 224.

In many embodiments, the component object model runtime 206A, 206B is substantially similar to the COM technology developed by MICROSOFT, while in other embodiments the component object model runtime 206A, 206B is a runtime, different from that of the MICROSOFT COM technology, and one that provides an interface standard able to use inter-process communication and dynamic object creation to utilize objects in multiple environments by providing an interface that is separate from the implementation of the object. In many embodiments, the component object model runtime 206A is configured to register the proxy linked and embedded object server 216 as a proxy for the linked and embedded object server 224 executing on the second computing machine 204. When, in many embodiments, interface calls are generated by either the container application 212 or the linked and embedded object server stub 222, the component object model runtime 206A on the first machine 202 functions to marshal said interface calls, and the component object runtime 206B on the second machine 204 functions to marshal said interface calls. Further, in many embodiments, the component object model runtime 206A on the first machine 202 has the following functionalities: to provide infrastructure for registering object types handled by the proxy linked and embedded object server 216; to locate and launch the proxy linked and embedded object server 216 when an embedded or linked object handled by the proxy linked and embedded object server 216 is activated; provide infrastructure for registering the proxy linked and embedded object class factories, where said class factories are responsible for creating instances of a server associated with the embedded or linked object; marshal interface calls between the container application 212 and the proxy linked and embedded object server 216; and provide the structured persistent storage infrastructure. To function properly, in most embodiments, the component object model runtime 206A can rely on the proxy linked and embedded object server 216 to register and de-register its object class factories, and the system to be configured such that the proxy linked and embedded object server 216 is identified as a proxy for remote linked and embedded object servers. The component object model runtime 206A on the first computing machine 202 is utilized, in some embodiments, to isolate the container application 212 from the proxy linked and embedded object server 216 and the linked and embedded object virtual channel client 218 so that the container application 212 remains limited to embedded and linked object interfaces. Thus, operation of an embedded or linked object relies in part on the marshalling of interface calls between the container application 212 and the proxy linked and embedded object server 216 by the component object model runtime 206A on the first computing machine 202.

In many embodiments, the proxy linked and embedded object server 216 is a pseudo linked and embedded object server application registered on a computer in lieu of an actual server application 224 when said server application 224 is located on a computer remote from the computer on which the container application 212 is located. Registering the proxy server 216 on the computing machine allows the container application 212 to interact with the proxy server 216 as though the proxy server 216 were a fully installed application. When, in many embodiments, an embedded or linked object type handled by actual server application 224 is activated in a container application 212 on the first computing machine 202, the component object model runtime 206A launches the proxy linked and embedded object server 216. When launched, the proxy linked and embedded object server 216 can, in many embodiments, determine which server application 224 it will represent via a command line parameter. In other embodiments, there can exist multiple copies of the proxy linked and embedded object server 216, where each copy corresponds to a particular server application 224.

The proxy linked and embedded object server 216, in some embodiments, operates much in the same way that the server application 224 operates. When registering the proxy server 216, in many embodiments the proxy server 216 is registered a number of times substantially equivalent to the number of server applications 224 the proxy server 216 can correspond to, where the setting for each proxy server 216 registration is specific to a corresponding server application 224. Further, if a corresponding server application 224 has the ability to handle multiple object types, then the corresponding proxy server 216 registration is configured to also handle multiple object types. In some embodiments, when a user activates multiple object types, then multiple proxy servers 216 may be running at the same time. Further, if any of the multiple proxy servers 216 are configured to handle multiple object types, then multiple proxy servers 216 may be running at the same time, where at least one of the proxy servers 216 further handles multiple object types. In one embodiment, the proxy server 216 and the linked and embedded object server stub 222 are implemented as interface proxies and stubs such that each of the proxy and the stub are implemented as an application level interface proxy and stub further isolating the impact of each of the proxy and the stub to only remote linked and embedded object server applications that the proxy is registered to act as a proxy for.

In one embodiment, the proxy linked and embedded object server 216 determines whether it is running in a terminal server session. Should such a determination be made, then the proxy server 216 will, in many embodiments, try to create a control channel to the linked and embedded object virtual channel stub 220B on the third computing machine 210 to further enable the system. Once the system is enabled, the proxy server 216 queries the remote protocol client 208B to determine if the server application 224 that it represents is available on the third computing machine 210. When it is determined that the server application 224 is available on the third computing machine 210, the proxy server 216 requests the remote protocol client 208B on the third computing machine 210 to launch the server stub 222B and the server application 224B on the third computing machine. The proxy server 216 then reads information about the document (object) types supported by the server application 224B that it is a proxy for from a configuration file or the from the system registry and registers a class factory for each of the object types. The proxy server 216 then creates a linked and embedded object virtual channel sub-channel between itself and the server stub 222B as the transport channel to remote interface method calls and responses and further intercepts linked and embedded object interface method calls, marshals them and forwards them to the server stub 222B via the OLE Virtual Channel. The proxy server 216 receives the results of a method call from the server stub 222B and forwards them to the container application 212. The proxy server 216 also receives method calls from the server stub 222B that originated from the server application 224B and invokes them to the container application 212, and further receives the response from the container application 212 and forwards it to the server stub 222B. In many embodiments, the proxy server 216 shuts down when the server application 224B shuts down.

In some embodiments, when the proxy server 216 is not running in a terminal server session, or otherwise cannot create a control channel, the proxy server 216 can launch the client 208A and request it to launch the linked and embedded object server stub 222 and the associated server application 224 in a seamless window. The proxy server 216 reads information about the document (object) types supported by the server application 224 that it is a proxy from a configuration file or the from the system registry and registers a class factory for each of the object types. The proxy server 216 then creates a sub-channel between itself and the server stub 222 as the channel over which the linked or embedded object interface method calls and responses can be sent. The proxy server 216 can then intercept interface method calls, marshal them and forward them to the server stub 222 via the OLE Virtual Channel, and further receive the results of a method call from the server stub 222 and forward them to the container application 212. The proxy server 216 also receives method calls from the server stub 222 that originated from the server application 224 and invokes them to the container application 212, and receives the response from the container application 212, forwards it to the server stub 222 and then shuts down when the server terminal server session shuts down.

The linked and embedded object virtual channel client 218 and the linked and embedded object virtual channel stub 220 together can, in some embodiments, create a linked and embedded object (OLE) virtual channel. In one embodiment, the OLE virtual channel operates to transmit interface method calls and responses between the proxy server 216 and the server stub 222. The virtual channel created between the client 218 and the stub 220 can, in many embodiments, do any combination of the following: convey a channel startup message from the proxy server 216 to the server stub 222 and vice versa; convey the object creation response message from the proxy server 216 to the server stub 222 and vice versa; convey linked and embedded object method call and response messages from the proxy server 216 to the server stub 222 and vice versa; convey object destruction messages from the proxy server 216 to the server stub 222 and vice versa; and convey channel shutdown messages from the proxy server 216 to the server stub 222 and vice versa. In many embodiments, the linked and embedded object virtual channel client can do the following: create the OLE virtual channel on the first computing machine 202; check to see if the user session is a terminal server session, and, when the session is not a terminal session, retrieve the list of OLE servers that the computing machine is permitted to access and send it to the virtual channel stub 220; and accept and relay requests and messages between the proxy server 216 and the server stub 222. The virtual channel stub 220 can, in some embodiments do any of the following: create the OLE virtual channel on the second computing machine 204; and transmit messages and requests amongst the proxy server 216, the server stub 222 and any other computing components. In many embodiments, the virtual channel created between the virtual channel client 218 and the virtual channel stub 220 is independent of the proxy server 216 and the server stub 222 thus allowing the virtual channel to multiplex messages from multiple instances of the proxy server 216 and the server stub 222.

The component object model runtime 206B on the second computing machine 204 can, in some embodiments, marshal interface calls between the server application 224 and the server stub 222. In some embodiments, the component object model runtime 206B has substantially the same characteristics and abilities of the component object model runtime 206A on the first computing machine 202. In other embodiments, the component object model runtime 206B can provide the following functionalities: provide infrastructure for registering objects handled by the server application 224; locate and launch the application server 224 when an embedded or linked object handled by that particular application server 224 is activated by the linked and embedded object server stub 222; provide infrastructure for registering the linked or embedded object's class factories; marshal interface calls between the server stub 222 and the server application 224; and provide the structured persistent storage infrastructure. Operation of the component object model runtime 206B can depend in part on the server application 224 registering and de-registering its object class factories; and the server application installed registering the server application 224 and the linked and embedded object types supported by that particular server application 224. Registration provides, in part, information necessary to match the server application 224 with a corresponding proxy server 216 when a linked or embedded object is activated.

In some embodiments, the linked and embedded object server stub 222 acts substantially similar to that of a proxy for the container application 212 on the first computing machine 202. These embodiments include a server stub 222 that communicates with the server application 224 via the component object model runtime 206B much in the same way that the container application 212 would interact with the server application 224 were the container application 212 and the server application 224 physically located in the same place. In many embodiments, the server stub 222 is launched by the client 208A when an embedded or linked object handled by the server application 224 is activated within the container application 212. When launched, the server stub 222, in many embodiments, determines the server application 224 that it represents. In these embodiments, the server stub 222 can accomplish this via a command line parameter, or by determining the application 224 from its filename. The server stub may, in many embodiments, be published under a different application name than the server application 224 it represents to distinguish itself and to further support the publication of different applications on different servers. In many embodiments, the server stub 222 does the following: creates its end of the OLE virtual channel used to provide remote access to method calls and responses between the proxy server 216 and the server stub 222; receive via the OLE Virtual Channel, interface method calls from the container application 212 marshaled by the proxy server 216 and invoke the calls on the server application 224; receive the results of the method calls from the server application 224, marshal the response and forward the response to the container application 212 via the OLE Virtual Channel and the proxy server 216; intercept method calls from the server application 224 to the container application 212, marshal the call and forward the call to the container application 212 via the OLE Virtual Channel and the proxy server 216; and shut down when the server application 224 shuts down. In many embodiments, the server stub 222 can keep track of the interface object reference counts, and can destroy the interface objects when the reference count reaches zero.

The server application 224 can be an application that, in many embodiments, registers itself with the component object model runtime 206B to handle specific linked or embedded object types. In some embodiments, the server application 224 can create, edit and render specific types of objects, or in other embodiments, may only be able to render specific types of objects. Functions performed by the server application 224, in many embodiments, include: presenting the document object in a window and allowing the user to edit the object; notifying the container application 212 when the object has been changed, saved, renamed or closed; updating the object stream in persistent storage; and rendering the object for display and print. The server application 224 can, in many embodiments, rely on the server stub 222 to activate it via the component object model runtime and the component object model runtime 206B to marshal and un-marshal method calls and responses between the server application 224 and the server stub 222.

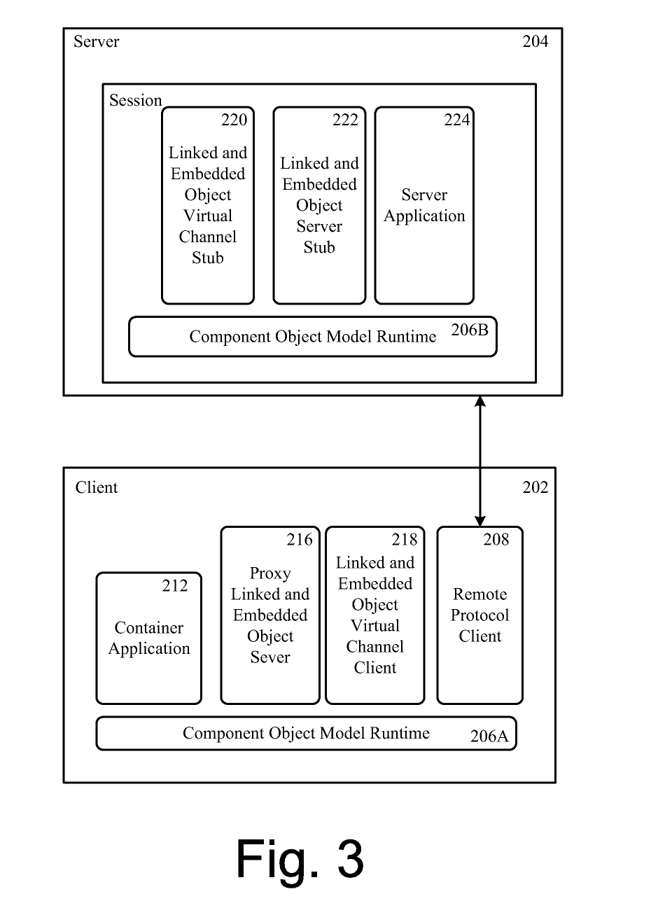

Illustrated in FIG. 3 is a version of the system described in FIG. 2. FIG. 3 illustrates an embodiment of a system for remoting OLE interfaces. The system includes a server 204 executing a session within which the following components execute: the linked and embedded object virtual channel stub 220, the linked and embedded object server stub 222, the server application 224 and the component object model runtime 206B. The server 204, in many embodiments, communicates with a client 202 executing the following components: a container application 212, a proxy linked and embedded object server 216, a linked and embedded object virtual channel client 218, a remote protocol client 208 and a component object model runtime 206A.

The system illustrated in FIG. 3 can include the same components having the same functionality as the components described in FIG. 2. Similarly the client 202 and the server 204 can comprise any of the computer components and functionalities described herein and can be any of the clients 202 or servers 204 described herein. The client 202 can be a first, second or third computing machine, while the server 204 can similarly be a first, second or third computing machine.

In one embodiment, the system illustrated in FIG. 3 differs from the system described in FIG. 2 in that the container application 212, the proxy linked and embedded object server 216 and the linked and embedded object virtual channel client 218 execute on a client 202 rather than on another server. Thus, the OLE interface calls issued by the container application 212 executing on the client 202 are remoted to the server 204 where they are handled by server application 224. Similarly, any OLE interface calls issued by the server application 224 executing on the server 204 are remoted to the client 202 where they are handled by the container application 212. In one embodiment, the client 202 uses the remote protocol client 208 to establish a virtual channel between the client 202 and the server 204 and to facilitate the transfer of data amongst the linked and embedded object virtual channel stub 220 and the linked and embedded object virtual channel client 218.

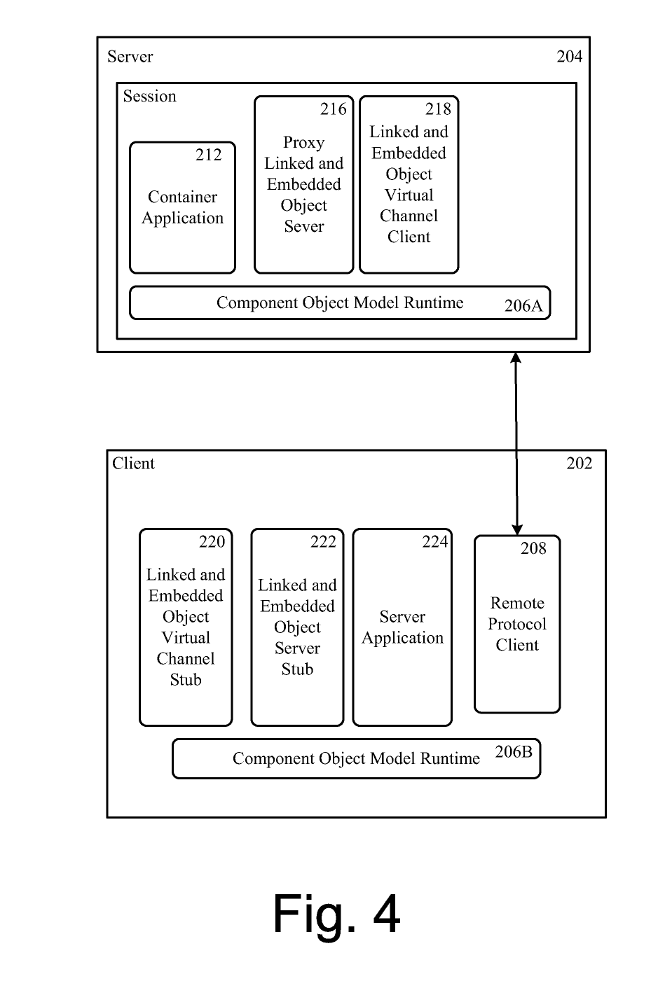

Illustrated in FIG. 4 is a version of the system described in FIGS. 2 and 3. FIG. 4 illustrates an embodiment of a system for remoting OLE interfaces. The system includes a client 202 executing a linked and embedded object virtual channel stub 220, a linked and embedded object server stub 222, a server application 224, a component object model runtime 206B and a remote protocol client 208. The client 202, in many embodiments, communicates with a server 204 executing the following components: a container application 212, a proxy linked and embedded object server 216, a linked and embedded object virtual channel client 218, and a component object model runtime 206A.

The system illustrated in FIG. 4 can include the same components having the same functionality as the components described in FIGS. 2 and 3. Similarly the client 202 and the server 204 can comprise any of the computer components and functionalities described herein and can be any of the clients 202 or servers 204 described herein. The client 202 can be a first, second or third computing machine, while the server 204 can similarly be a first, second or third computing machine.

In one embodiment, the system illustrated in FIG. 4 differs from the system described in FIG. 3 in that the container application 212, the proxy linked and embedded object server 216 and the linked and embedded object virtual channel client 218 execute on a server 204 rather than on the client 202. Similarly, the linked and embedded object sever stub 222, the linked and embedded object virtual channel stub 220, and the server application 224 execute on the client 202 rather than on the server 204. Thus, the OLE interface calls issued by the container application 212 executing on the server 204 are remoted to the client 202 where they are handled by server application 224. Similarly, any OLE interface calls issued by the server application 224 executing on the client 202 are remoted to the server 204 where they are handled by the container application 212. In one embodiment, the client 202 uses the remote protocol client 208 to establish a virtual channel between the client 202 and the server 204 and to facilitate the transfer of data amongst the linked and embedded object virtual channel stub 220 and the linked and embedded object virtual channel client 218.

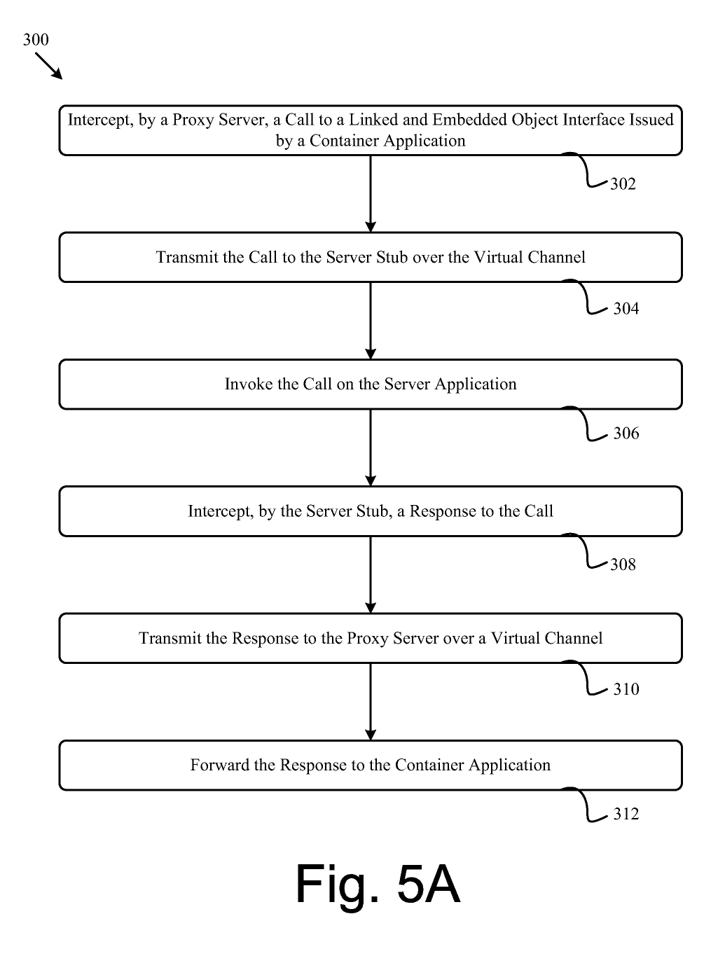

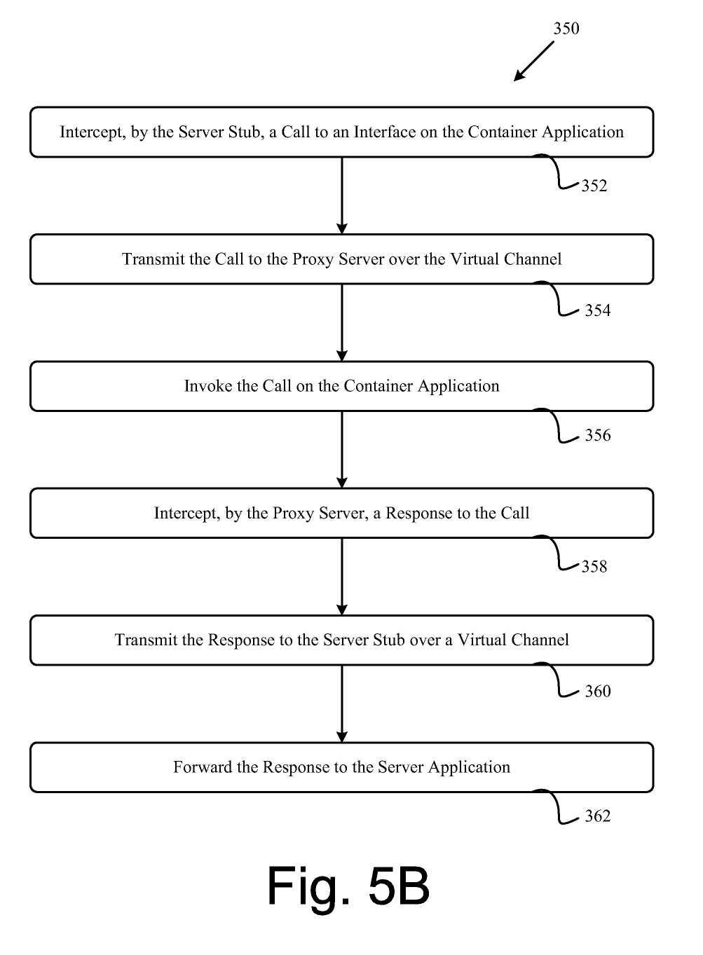

Illustrated in FIG. 5A is one embodiment of a method 300 for remoting OLE interface calls. In one embodiment, a proxy server executing on a first computing machine can intercept a call issued by a container application to a linked and embedded object interface (Step 302). Upon intercepting the call issued by the container application, the proxy server can then transmit the call to a server stub executing on a second computing machine (Step 304). The server stub, upon receiving the call, can then invoke the call on a server application executing on the second computing machine (Step 306). In one embodiment, the server stub can intercept a response to the call generated by the server application (Step 308) and can then transmit the response to the proxy server over a virtual channel (Step 310). Upon receiving the response, the proxy server application can then forward the response to the container application on the first computing machine (Step 312).

Further referring to FIG. 5A, and in more detail, in one embodiment the proxy server application can intercept a call issued by the container application (Step 302). The call can be, in some embodiments, a method call while in other embodiments can be a call issued responsive to instantiating an instance of an object type on the first computing machine. In other embodiments, the proxy server, upon intercepting the call, marshals the call prior to transmitting the call to the server stub on the second computing machine. Marshalling the call can include, in some embodiments, passing the call amongst threads or processes executing on a computing machine.

Prior to intercepting the call, the component object model runtime can, in some embodiments, respond to the activation of an object by launching the proxy server application. For example, if a user were to activate an object either linked or embedded in a container application, the activation of the object could cause the COM runtime to launch a proxy server application associated with the activated object.

Upon intercepting the call, the proxy server application can then transmit the call to the server stub over a virtual channel (Step 304). Upon receiving the call, in some embodiments, the server stub can un-marshal the call prior to invoking the call on the server application (Step 306). In one embodiment, the call is forwarded by the proxy server application to the linked and embedded object virtual channel client 218 which then transmits the call to the linked and embedded object virtual channel stub 220. The linked and embedded object virtual channel stub 220 can then forward the call to the linked and embedded object server stub 222.

Invoking the call on the server application 224 (Step 306) can include issuing or otherwise forwarding the call to the server application 224. In some embodiments, invoking the call on the server application 224 can include invoking the call on an interface on the server application 224. The server application 224, upon receiving the call, can process the call and generate a response. The server stub 222 can, in some embodiments, intercept the response generated by the server application 224 responsive to the call issued by the container application 212 (Step 308). Upon intercepting the response the server stub 222, in some embodiments, can marshal the response prior to transmitting the response to the proxy server over the virtual channel (Step 310). In other embodiments, the server stub 222 may not marshal the call prior to transmitting the call over the virtual channel to the proxy server application 216 executing on the first computing machine. The server stub 222, in some embodiments, can transmit the intercepted call to the linked and embedded object virtual channel stub 220 which then transmits the response over the virtual channel to the linked and embedded object virtual channel client 218 which then forwards the call to the proxy server 216. Once the proxy server 216 receives the response, the proxy server application 216 can then forward the response to the container application 212 (Step 312). In some embodiments, the proxy linked and embedded object server 216 can un-marshal the call prior to forwarding the call to the container application 212.

Illustrated in FIG. 5B is an embodiment of a method 350 for transmitting a call issued by a server application 224 to a container application 212. A server stub executing on a second computing machine can intercept a call to an interface on a container application 212 (Step 352). The intercepted call can then be transmitted to a proxy server 216 on a first computing machine over a virtual channel (Step 354). Once the call is received by the proxy server 216, the proxy server 216 can then invoke the call on the container application 212 (Step 356), intercept the response (Step 358) and transmit the response to the server stub 222 on the second computing machine over the virtual channel (Step 360). Upon receiving the response, the server stub 222 can then forward the response to the server application 224 (Step 362).

Further referring to FIG. 5B, and in more detail, in one embodiment the server stub 222 intercepts a call issued by the server application 224 (Step 352). The call can be for access to an interface on the container application 212. In some embodiments, the call can be for access to a linked and embedded object interface on the container application 212.

The call, in some embodiments, can be intercepted by server stub 222 which either forwards the call to the linked and embedded object virtual channel sub 220 for transmission over the virtual channel, or can be transmitted directly by the server stub 222 over the virtual channel to the first computing machine (Step 354). The call is received by the first computing machine and the proxy server 216 receives the call and invokes the call on the container application 212. The container application 212 responsively generates a response to the call which is intercepted by the proxy server 216. In some embodiments, the proxy server 216 can un-marshal the call prior to invoking the call on the container application 212, and in other embodiments the proxy server 216 can marshal the intercepted response prior to transmitting the response over the virtual channel to the linked and embedded object server stub 222 (Step 360). Once the server stub 222 receives the response, the server stub 222 can forward the response to the server application 224.

Now referring to FIG. 6 which illustrates an embodiment of a method 400 for transmitting calls and responses within the above-described system. Method calls are intercepted by the proxy server 216, wherein each method call or request is a call to a linked and embedded object interface (step 402) either on the container application 212 or on the server application 224. The proxy server 216 then marshals the call and further transmits the call to a corresponding proxy container application or linked and embedded object server stub 222 on a computing machine remote from the computing machine on which the call originated (step 404). The method call to the linked and embedded object interface is received by a server stub 222, or proxy container application (step 406). The server stub 222 then un-marshals the call and invokes the call on the server application 224 (step 408). A response to the method call is generated by the server application 224 and subsequently intercepted by the server stub 222 (step 410). In some embodiments, a method call issued to one or more interfaces on the container application 212 is intercepted by the server stub 222 (step 412). The server stub 222 then marshals the methods calls and the responses and further transmits the calls and the response to a computing machine remote from the computing machine on which the calls and responses originated (step 414). Each of the method calls and responses are received by the proxy server 216 (step 416), which then un-marshals the responses and forwards them to the container application 212 (step 418) and un-marshals the calls and invokes the calls on the container application 212 (step 420).

One embodiment of the method 400, includes requests received by the proxy server 216 class factory to create an instance of an object type results in the class factory creating a proxy object for the real object on the server application (step 402). The proxy object supports all the COM and OLE interfaces required by the container application 212 and server application 224 to interact with each another. The request is marshaled by the proxy server 216 and forwarded to the server stub 222 (step 404) which receives the request (step 406) un-marshals the call and invokes the method call on the server application 224 (step 408) which results in the server application 224 being activated. The server application 224 creates and initializes the real object and returns an interface pointer to the interface requested by the container application 212 to the server stub 222. The server stub 222 generates a unique interface identifier (ID) for each unique interface instance it receives from the server application 224 and adds the interface ID and interface pointer pair into a table which is used to map interface method calls to the correct interface instance in the server stub 222. In this embodiment, steps 410-420 are not included. Rather, the embodiment further includes passing the interface ID, by the server stub 222, to the proxy server 216 as a reference to the interface instance in the server stub 222. The proxy server 216 associates this interface ID to the corresponding interface on its proxy object and returns the corresponding interface pointer on the proxy object to its caller. The proxy server 216 also generates a unique interface ID for each unique interface pointer it receives from the container application 212 and it also adds the interface ID and interface pointer pair into a table which is used to map interface method calls to the correct interface instance in the proxy server 216. The interface ID is then used by the proxy server 216 and the server stub 222 as a reference to the interface pointer whenever the interface pointer is required in messages exchanged between the proxy server 216 and the server stub 222. Simple data types and structures containing simple data types are marshaled by value. Pointers are followed until the entities they point to can be resolved to simple data types which are then marshaled by value. Some entities such as handles only have meaning on the computer that created them, in these cases the entity properties must be marshaled and entity recreated on the other computer.

The methods and systems described herein may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While the present disclosure has described multiple embodiments of systems and methods for launching an application into an existing isolation environment, it should be understood by those skilled in the art that various changes in form and detail may be made therein without departing from the spirit and scope of the invention as defined by the following claims.

What is claimed is:

1. A method for remoting calls issued by container applications to linked and embedded objects, the method comprising:
launching, by an object module manager executing on a first computing machine, a proxy server application on the first computing machine responsive to activating an object associated with the proxy server application;
intercepting, by the proxy server application, a call issued by a container application executing on the first computing machine;
transmitting, by the proxy server application over a virtual channel via a presentation level protocol, the intercepted call to a proxy container application executing on a second computing machine,
the proxy container application invoking the call on a server application executing on the second computing machine and associated with the object;
receiving, by the proxy server application from the proxy container application via the virtual channel, a response generated by the server application and comprising data associated with the object; and
forwarding, by the proxy server application, the received response to the container application.

2. The method of claim 1, wherein intercepting a call further comprises intercepting a call requesting access to a linked and embedded object interface on the server application.

3. The method of claim 1, wherein intercepting a call further comprises intercepting a method call.

4. The method of claim 1, wherein launching a proxy server application further comprises launching a proxy server application associated with the activated object.

5. The method of claim 1, further comprising:
receiving, by the proxy server application from the proxy container application, a second call issued by the server application to an interface on the container application, the second call transmitted by the proxy container application to the proxy server application over the virtual channel; and
invoking, by the proxy server application, the second call on the container application.

6. The method of claim 1, wherein the server application further comprises an object linking and embedding server application associated with the activated object.

7. The method of claim 1, wherein the proxy server application on the first computing machine corresponds to the server application on the second computing machine.

8. The method of claim 1, wherein the container application on the first computing machine corresponds to the proxy container application on the second computing machine.

9. The method of claim 1, wherein the container application executes on a third computing machine.

10. The method of claim 1, further comprising:
marshalling, by the proxy server application, the call prior to transmitting the call to the proxy container application;
un-marshalling, by the proxy container application, the call prior to invoking the call on the server application.

11. The method of claim 1, further comprising:
marshalling, by the proxy container application, the response to the call prior to transmitting the response to the proxy server application; and
un-marshalling, by the proxy server application, the response prior to transmitting the response to the container application.

12. The method of claim 1, wherein the first computing machine and the second computing machine are substantially the same computing machine.

13. The method of claim 1, further comprising receiving, by the proxy server application prior to intercepting the call, a request issued by the container application to create an instance of the activated object; and creating the object instance.

14. The method of claim 13, further comprising:
invoking, by the proxy container application, the request issued by the container application on the server application after receiving the request from the proxy server application; and
transmitting, by the proxy container application, a pointer to an interface associated with an object created by the server application responsive to the request, the object corresponding to the object instance.

15. The method of claim 14, further comprising:
storing, by the proxy server application, the received pointer in a table; and
mapping, by the proxy server application, the object instance to the stored pointer.

16. The method of claim 15, wherein storing further comprises storing in a table on the first computing machine.

17. The method of claim 15, wherein storing further comprises storing in a table on a computing machine remotely located from the first computing machine.

18. The method of claim 1, wherein the container application executes on a third computing machine.

19. The method of claim 1, wherein the presentation level protocol remotes keyboard input, mouse input, audio output and screen updates between computing machines.

20. A system for remoting calls issued by container applications to linked and embedded objects, the system comprising:
an object module executing on a first computing machine, the object module detecting activation of an object and responsively launching a proxy server application associated with the object;
a container application executing on the first computing machine and issuing a call to an interface on a server application executing on a second computing machine;
a server application executing on the second computing machine, the server application associated with the object; and
a proxy container application executing on the second computing machine and invoking received calls on the server application;
a proxy server application executing on the first computing machine, the proxy server application:
intercepting the call issued by the container application,
transmitting the call to the proxy container application over a virtual channel,
receiving from the proxy container application, via the virtual channel, a response generated by the server application and comprising data associated with the object, and
forwarding the received response to the container application.

22. The system of claim 20, wherein the proxy server application intercepts a call requesting access to a linked and embedded object interface on the server application.

23. The system of claim 20, wherein the proxy server application intercepts a method call.

24. The system of claim 20, wherein the object module launches a proxy server application associated with the activated object.

25. The system of claim 20, wherein the proxy server application:
receives, from the proxy container application, a second call issued by the server application to an interface on the container application, the second call transmitted by the proxy container application to the proxy server application over the virtual channel; and
invokes the second call on the container application.

26. The system of claim 20, wherein the server application further comprises an object linking and embedding server application associated with the activated object.

27. The system of claim 20, wherein the proxy server application on the first computing machine corresponds to the server application on the second computing machine.

28. The system of claim 20, wherein the container application on the first computing machine corresponds to the proxy container application on the second computing machine.

29. The system of claim 20, wherein the container application executes on a third computing machine.

30. The system of claim 20, wherein the proxy server application marshals the call prior to transmitting the call to the proxy container application; and the proxy container application un-marshals the call prior to invoking the call on the server application.

31. The system of claim 20, wherein the proxy container application marshals the response to the call prior to transmitting the response to the proxy server application; and the proxy server application un-marshals the response prior to transmitting the response to the container application.

32. The system of claim 20, wherein the first computing machine and the second computing machine are substantially the same computing machine.

33. The system of claim 20, wherein the proxy server application receives, prior to intercepting the call, a request issued by the container application to create an instance of the activated object, and creates the object instance.

34. The system of claim 33, wherein the proxy container application:
invokes the request issued by the container application on the server application after receiving the request from the proxy server application; and
transmits a pointer to an interface associated with an object created by the server application responsive to the request, the object corresponding to the object instance.

35. The system of claim 34, wherein the proxy server application stores the received pointer in a table, and maps the object instance to the stored pointer.

36. The system of claim 35, wherein the proxy server application stores the received pointer in a table on the first computing machine.

37. The system of claim 35, wherein the proxy server application stores the received pointer in a table on a computing machine remotely located from the first computing machine.

38. The system of claim 20, wherein the container application executes on a third computing machine.

39. The system of claim 20, wherein the presentation level protocol remotes keyboard input, mouse input, audio output and screen updates between computing machines.
